(19) United States
(12) Patent Application Publication
(10) Pub. No.: US 2012/0116825 A1
(43) Pub. Date: May 10, 2012

(54) METHODS AND SYSTEM MAKING IT POSSIBLE TO PLACE AN INDIVIDUAL PUBLIC VEHICLE AT THE DISPOSAL OF A USER

(76) Inventors: Georges Bernard Marie Paul Antoine Gallais, Antibes (FR); David Serge Ange Andre Emsellem, Antibes (FR); David Pierre Marie Gibory, Antibes (FR)

(21) Appl. No.: 12/598,197

(22) PCT Filed: Apr. 8, 2008
(86) PCT No.: PCT/FR08/00490

§ 371 Date: Mar. 22, 2010

(30) Foreign Application Priority Data
Apr. 30, 2007 (FR) 0703139
Jun. 8, 2007 (FR) 0704117

(51) Int. Cl. G06Q 10/00; G06K 19/073; G07B 15/00; G07C 11/00; G07C 5/00; G06F 17/30; G07C 1/10

(52) U.S. Cl. 705/5

(57) ABSTRACT

Method for placing one vehicle of a group of individual public vehicles at the disposal of a user, the said method being characterized in that it comprises the following steps: receiving from each individual public vehicle information including the geographic position of the vehicle, creating a database including the information of the geographic positions of the vehicles, receiving a request to place a vehicle at the disposal of the user in a position, using the database to identify a vehicle available in this position or close to this position, and sending the user the information relating to the actual exact position of the available vehicle.

The invention relates to a method allowing an individual public vehicle to be placed at the disposal of a user.

Urban transport, the major cause of energy and environmental problems, is threatening to jeopardise our development model. It is responsible for more than one third of noxious emissions and is a major concern for town councils. Mobility is characterised by a high proportion of what are known as “local” journeys, carried out over short distances. In order to highlight this aspect, it may be assumed that 50% of all in-town journeys are carried out over a distance of less than 5 kilometres. In a town centre, that represents several tens of thousands of daily trips, currently carried out by opposing services: on the one hand individual private vehicles and on the other collective means of public transport.

The use of individual private vehicles has the great advantage of offering total freedom of use of the user's own means of transport. Collective public transport helps to limit the energy and environmental problems identified hereinbefore.

A plurality of experiments have attempted to offer a semi-private, semi-collective form of transport, limiting environmental problems while at the same time offering users sufficient freedom and flexibility.

The concept of “car sharing” offers the use of vehicles to individuals who, once they have registered with the service provider, can use vehicles, sequentially, as according to their availability.

According to the prior art, a system was identified in which a reservation allows a user to reserve a vehicle in advance.

The user has to indicate a duration of use, use and return the vehicle within the time slot agreed in advance. Moreover, according to the prior art, the vehicle must be collected from and returned to a specific station. If such a system is used in a highly populated location, it will be necessary to provide a large number of stations in order to meet as many user requests as possible, for example within a radius of 500 metres around each station.

Examples of a system operating as indicated hereinbefore include the European system launched under the name “Moses”. In order to break even, this project requires about 500 vehicles, resulting in the difficulties associated with the investment needed to launch the system.

In order to improve the freedom and flexibility of use, it is possible to envisage a “one-way” solution, in which case the user leaves the vehicle at any desired station. If the system operates in this way, this gives rise to the problem of redistribution between stations. This redistribution pushes up the operating costs. That is to say, it necessitates the employment of staff specialised in the redistribution of vehicles to the various stations where demand outstrips supply at a given moment. The complexity of these problems increases in tandem with the radius of the site where the system is employed.

Another option allowing the “one-way” solution may be found in a technology known as “platooning”. This system consists in hitching, in whatever manner, the vehicles to be redistributed, to another vehicle driven by a team member.

This solution functionally solves the problem but the travel time for balancing out the stations remains the same. This solution will also be proportional to the distances covered and involves additional equipment and labour costs.

The object of the invention is to provide a system offering the user maximum freedom, to allow him to carry out short-distance journeys corresponding to a spontaneous demand.

A second object of the invention is to offer a system eliminating the need for a conventional reservation. In this case, the user does not have to know in advance either the date or the duration of his trip.

Associated with the objects identified hereinbefore, another object of this invention is to ensure users will have access to a vehicle, at any time and in any place, while minimising the number of vehicles and the redistribution costs.

In accordance with the foregoing observations, the object of the invention is to provide a method making it possible to place a public vehicle at the disposal of a user while avoiding the constraints of use inherent to the systems according to the prior art.

Firstly, the invention relates to a method for placing at the disposal of a user one vehicle, to be used by this user, from a group of individual public vehicles, said method being characterised in that it includes the following steps:
obtaining from the vehicles of this group information concerning the geographical position of the vehicle,
obtaining from the vehicles of this group information concerning their availability for a user,
sending the information concerning the geographical position of the vehicles and their availabilities to a computer centre,
receiving and storing at the computer centre the information concerning the geographical position and the availability of the vehicles,
receiving at the computer centre a request to place at the disposal of a user a vehicle at a position,
comparing the information concerning the geographical position and the availability of the vehicles received at the computer centre with the request to provide a vehicle,
identifying a vehicle which is available at the position indicated by the user or close to this position, and
sending the user information concerning the geographical position of the available vehicle.

According to the invention, all the vehicles transfer to a central electronic station the information relating to their position. This central electronic station comprises a database listing the exact position of the vehicles. After receipt of a request to provide a vehicle, the information found in the database is used to identify a vehicle available nearby. In order to be able to identify the closest vehicle, the user's request must mention an item of information relating to the location where he wishes to pick up the vehicle.

A first technical effect of the method according to the invention consists in the fact that a user can identify the presence of the vehicle without moving. The user can indicate his location and receive, in accordance with the method, a precise indication of the location of the available vehicle. That also means that once he has used it, the user can park the vehicle at his location of choice, as he wishes. The next user can easily identify the available vehicle using the method according to the invention.

An important advantage of the method according to the invention consists in the fact that the method can be implemented without the need for fixed stations. The user has neither to pick up the vehicle from, nor to return it to a fixed station. That means that the flexibility of the method according to the invention is much greater than that offered by the system according to the prior art.

Secondly, the method according to the invention has the advantage that the user does not need to reserve the vehicle long in advance. The method according to the invention instantaneously provides the user with information concerning the availability of a vehicle, regardless of its location. If the user decides to use a vehicle at a specific time, it is possible for him to identify the location of the nearest available vehicle at that time.

According to a preferred embodiment, the method according to the invention includes a step which allows the information relating to the geographical movements of the vehicles to be received from each individual public vehicle, a database to be created comprising the information of these movements, the database to be used in order to calculate indices. These indices, relating to the movements of the vehicles in a geographical area, allow predictions to be made on the future movements of the vehicles in this area. The technical result of this characteristic is that the database records all the movements of all the vehicles. That means that, in accordance with the invention, the information listed in this database can be used to learn in what way the vehicles are used by the user. The information can indicate the average length of a journey, the typical duration of use of a vehicle and in which geographical area the vehicles have been used.

The items of information, concerning the movements of the vehicles, recorded in the database are important indices revealing the location to which the car has to be distributed, for example, once an operator has acted on the system (maintenance, recharging the battery, etc.).

Moreover, this information can also be used to predict the movements of vehicles in the system. That is very important in order to be able, for example, to calculate the waiting time before a vehicle will become available.

The fact that the movements of all the vehicles in the system are recorded reveals the most common manner in which the vehicles are used, in accordance with the invention, in a given geographical area. As a result, the operator will be able to adapt his system, as and when, according to the users' needs.

According to a preferred embodiment, the method includes the step of providing each individual public vehicle with a characteristic concerning its availability, receiving a request to provide a vehicle, confirming the availability of a certain vehicle, changing the characteristic of this vehicle from a first “available” state to a second “unavailable” state.

According to the invention, each vehicle is provided with a means for indicating its availability. The various possibilities are for example:
I am available;
I am reserved by a user who wishes to use me within the next 15 minutes;
I am unavailable.

These very precise options concerning the availability of the vehicles allow all the available vehicles to be identified rapidly, in accordance with the method. Moreover, once a user's request has been received, the status of a vehicle can be modified, changing for example from a first status “I am available” to a second status “I am reserved” or else “I am reserved by a person who wishes to use me within the next 15 minutes”.

According to a preferred embodiment, the system providing a public vehicle for a user comprises a computer centre and one or more vehicles. This computer centre is provided with communication means for communicating with each vehicle. The vehicles are themselves provided with precise locating means and with communication means for sending information concerning their geographical position to this computer centre.

This characteristic allows the status of a vehicle to be changed automatically if a certain condition is not met. For example, if a vehicle is reserved by a user and if the user does not turn up to pick up the vehicle within a given time (for example 15 minutes), the status of this vehicle can change. It will move from a second status “I am reserved” to a first status “I am available”.

Secondly, the invention relates to a system wherein the communication means are adapted to allow the vehicles to send information concerning their geographical position, continuously.

The system according to the invention can be put in place by an operator. This operator is responsible for the management of the computer centre. This computer centre typically comprises a computer provided with a software package allowing the transmitted data sent by the vehicles to be received and processed. The computer centre also comprises elements allowing communication between the computer centre and the users, as will be explained in detail hereinafter.

Typically, the computer centre and the vehicles are provided with communication means for sending and receiving information relating to the geographical position of the vehicles and to the status of a vehicle (available, reserved, or unavailable).

According to a preferred embodiment, the system comprises the computer centre adapted to communicate with a user and allowing the user to access the information concerning the geographical position of the vehicles.

According to the invention, the information concerning the geographical position of each vehicle can be transmitted to the computer centre. They can be sent continuously. Alternatively, the information can be stored on a computer on board the vehicle and can be transmitted to the computer centre, for example every 5 minutes. The most important thing is to be able to transmit to the computer centre precise and recent information concerning the position and the state of each vehicle listed in the system.

According to a preferred embodiment, the system according to the invention comprises communication means adapted for GSM, 2G, 3G, WIFI or WIMAX-type wireless communication. Any other appropriate communication means may also be used.

According to the invention, a user can contact the computer centre directly. The computer centre can, firstly, check whether the user is properly registered. After this first check, the computer centre can provide access to the information concerning the position and the availability of the vehicles. During the communication between the computer centre and the user, the user can send commands concerning for example the reservation of a specific vehicle. According to a preferred embodiment, the system is adapted for communicating with a vehicle provided with precise locating means allowing the vehicle to know its exact geographical position and with communication means for sending its exact position.

Thirdly, the invention relates to a vehicle provided with means for communicating with a user, so that a vehicle recognises a registered user and so that the user accesses the vehicle. According to the preferred embodiment, the vehicle according to the invention is provided with means for communication between the vehicle and the user, equipped with authentication means. The identification means, in a preferred embodiment, use an RFID protocol. Alternatively, the identification means can use means known in the technical field with near field contact. In such a case, an RFID smart card is inserted into a device which the user carries with him. That means that the smart card is added to a telephone, a bag or any other device that the user carries with him.

According to the invention, it is possible for a user to turn up at an available vehicle or a vehicle reserved by him. When the user turns up at a vehicle, communication is possible between the vehicle and the user. The vehicle can check whether the user is indeed entitled to use this specific vehicle. If the check is positive, the vehicle can, for example, unlock the door and give the user access to the vehicle. At the same time, the vehicle can transmit information to the computer system in order to change its state (for example from “I am available” to “I am unavailable”).

According to a preferred embodiment, the vehicle is provided with a display device, visibly indicating the availability characteristic of the vehicle. The technical effect of this characteristic is that the user can possess a smart card.

When the user is near to a vehicle available for him, he presents this smart card. The vehicle can read the information on the smart card and can note the presence of the authorised user.

The presence of means allowing the status of a vehicle to be visibly indicated facilitates the use of said vehicle.

Fourthly, the invention relates to a computer program comprising data and instructions which, after loading by a processing configuration, enable said configuration to carry out the method according to the invention; moreover, the invention relates to a data medium provided with a computer program of this type.

The mode of operation of the invention will be better appreciated after the following description with reference to the drawings, in which:

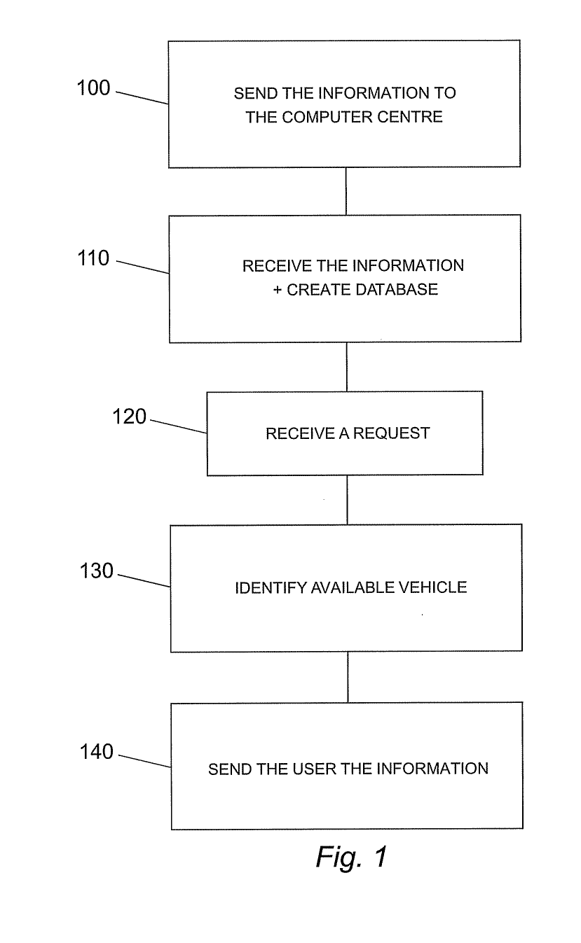

FIG. 1 shows the steps of the method according to the invention;

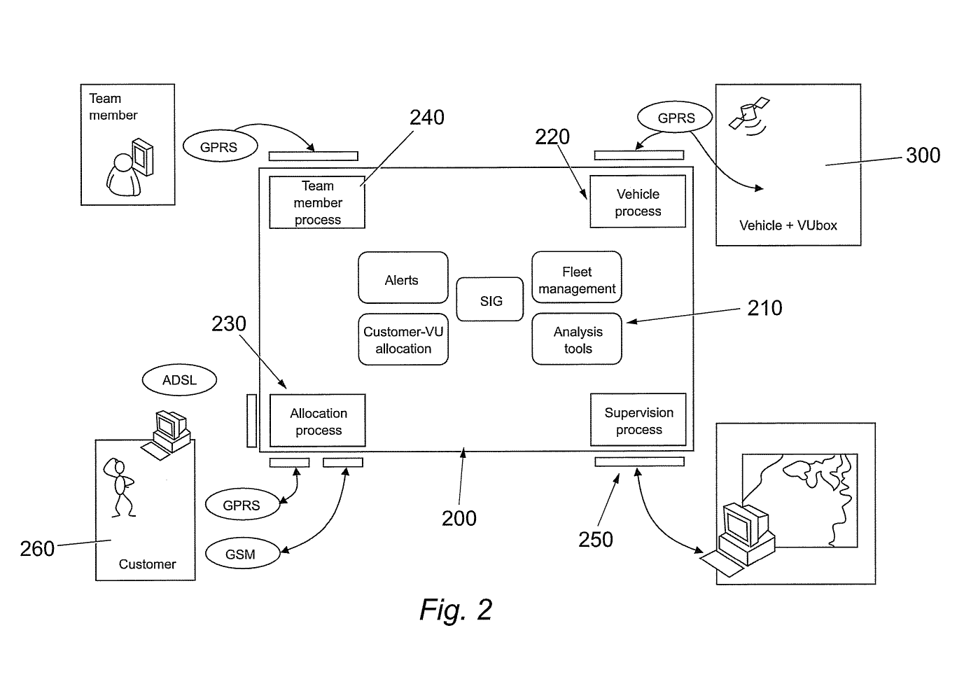

FIG. 2 shows schematically the various elements of the system according to the invention;

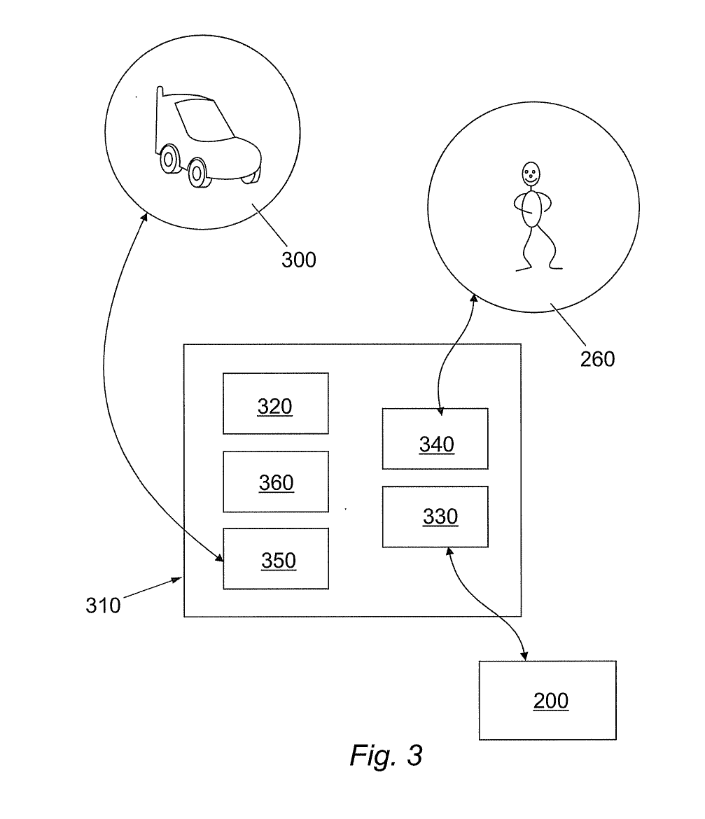

FIG. 3 shows schematically an individual public vehicle according to the invention; and

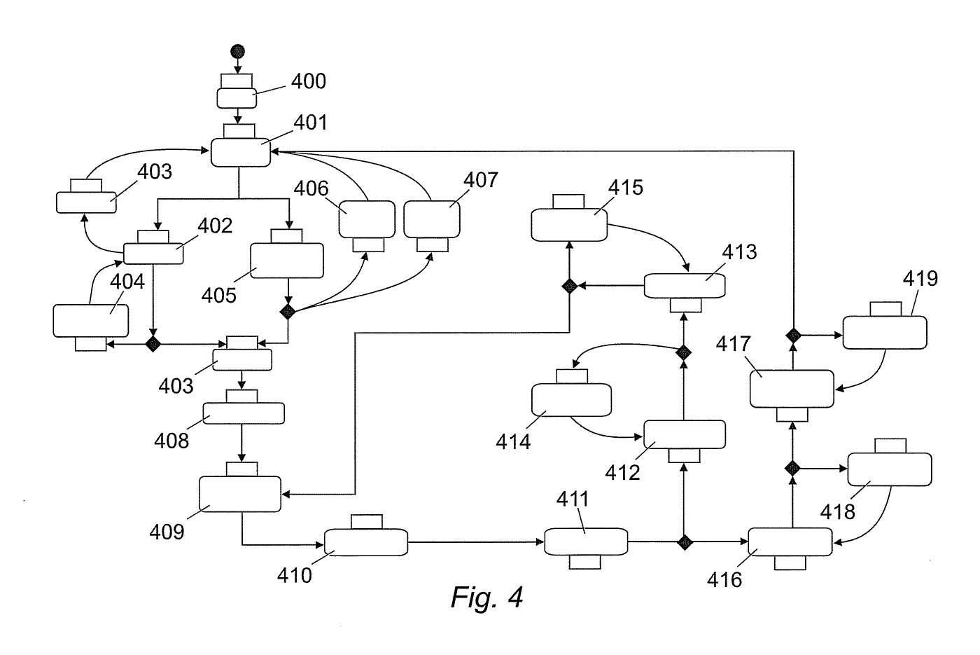

FIG. 4 shows the various possibilities for communication between the computer centre, a vehicle and a user.

FIG. 1 shows the various steps of the method according to the invention. According to the invention, in a first step 100, an individual public vehicle transmits information, relating to its geographical position, to a computer centre. Moreover, an individual public vehicle can transmit, intermittently or continuously, information concerning the movements of the vehicle in a geographical area.

In the second step 110, the various elements of information from each vehicle of the system are received by a central computer centre. In this central computer centre, a database is created comprising all the various items of information concerning the positions and the movements of the vehicles in the system.

In a third step 120, the computer centre receives a request from a user, requesting the provision of an available vehicle.

In a fourth step 130, the system will seek to identify an available vehicle, using the information in the database, and to place it at the disposal of the user. The selection is made based, for example, on the user's present position. The system will seek to identify an available vehicle sufficiently close to the user's position.

Once the system has identified an available vehicle or once the waiting time has been successfully calculated, the information is transferred to the user. This step is indicated by number 140 in FIG. 1.

The information transferred to the user may be:
we have identified an available vehicle and the available vehicle is at this position;
we have not found an available vehicle just yet, but we promise that we will be able to provide a vehicle in about 25 minutes; or
any other information of assistance to the user.

In FIG. 2, the various elements of the system according to the invention are indicated schematically. The system comprises a computer centre 200, which forms the hub of the system according to the invention. The electronic centre is provided with the elements relating to the management of the fleet of vehicles, the analysis tools, the database for managing the users' details, the system and the other general software packages concerning the management of the system. The various elements are indicated at the hub of the computer centre and are indicated by reference numerals 210.

An important element of the computer centre 200 is the presence of the communication means for communicating with the individual public vehicles and for thus obtaining information on the precise position of the vehicles. Reference numeral 220 denotes the vehicle method. That means all the computer elements, the software packages allowing the computer centre to communicate with the vehicle and to process the data transmitted by the vehicles. The computer centre can communicate with the vehicles owing to a GPRS protocol or any other appropriate communication means.

Number 230 indicates schematically the “allocation” process. That means all the computer equipment and all the software packages necessary for communication with a customer.

A customer can contact the electronic centre 200 to create, firstly, a customer file. The customer can identify himself and can indicate the means of payment that he wishes to use in order to use the system.

Moreover, the “allocation” process indicates the possibility to a customer of contacting the system to request the provision of a vehicle. With the “allocation” process, the customer sends his request and the system confirms to him the availability of a vehicle and the location where he can pick up this vehicle. The customer can communicate with computer centre using, for example, a computer, a PDA, a mobile telephone or using any other communication means available. The communication can be triggered using text. For communication between the customer and the computer centre, a protocol using tick boxes may also be used.

Number 240 indicates the “team member” process. In the text, the word “team member” indicates a person who picks up a vehicle and redistributes it within the system. That means that, if a vehicle requires maintenance, the team member can look for the vehicle and carry out the necessary maintenance. This maintenance may, for example, consist in recharging the battery of an electric vehicle. In the case of heat-powered or hybrid vehicles, that may consist in an action for filling the tank of the car with petrol. The team members are also used to redistribute the vehicles within the system if it becomes apparent that too many vehicles are at the same place. If there is a discrepancy between the positioning of the vehicles and the typical needs of the users, the team member can be used to improve the distribution of the vehicles within the system. The communication between the computer centre and the team member may be carried out by all appropriate means, for example a GPRS protocol. A team member receives on his portable computer the indication of an action to be taken, can respond to the system and take responsibility for an action to be taken if necessary.

Another form of contact with the computer centre may consist, for example, in a supervision process 250. A process of this type may be implemented to allow any desired body to monitor the operation of the system. If the system is used in a town, a department of the town council can, for example, monitor the movements of the vehicles or citizens' participation in the system, analyse the specific indices concerning the system, monitor the costs of the system for the community or else perform any other appropriate interoperations.

In a preferred embodiment, the computer centre 200 allows feasibility studies and therefore helps to prepare for consultations. These consultations can relate to the market, the size of the system, the overall number of vehicles required, the mode, and for example planning.

The computer centre can serve a certain geographical area. The computer centre can be used for the district of a town. Alternatively, a single computer centre is used to serve a plurality of districts or an even larger geographical area.

Another element of the computer centre is the presence of the very precise mapping data. The mapping data are normally provided by mapping data suppliers such as NAVTEQ or TEL ATLAS. The system of conventional suppliers is updated regularly, i.e. at least once per year. Such a method for preserving the mapping data is not sufficient for the system according to the invention. By intensive communication between the electronic centre and the vehicles used by the system, the mapping data according to the invention are updated on a daily basis. The precise geographical positioning, used in the system under urban conditions such as “narrow roads, underground car parks”, means that the GPS signals have to be supplemented with measurements from on-board sensors. These on-board sensors are, for example, odometers and gyrometers. That means that all the vehicles listed in the system allow updating of the mapping data used in the system. If, for example, a car is parked in a road which, according to the mapping data provided by one of the major suppliers, does not exist, the characteristics of this road can be added in order to update the mapping data. FIG. 3 shows schematically a vehicle 300, the purpose of which is, inter alia, to record the movements of vehicles and to communicate on the one hand with the computer centre 200 and on the other hand with a user 260.

The electronic unit 310 comprises, inter alia, precise locating means 320. Preferably, this precise locating means comprises a GPS which is highly accurate, for example accurate to within 5 metres. The precise locating means allow the vehicle 300 to be located.

The electronic unit 310 comprises communication means 330 allowing bidirectional communication with the computer centre 200. Moreover, the electronic unit 310 comprises the identification means for allowing a registered user 260 to access the vehicle 300. These authentication means 340 also allow the use of the vehicle to be invoiced according to the personalised parameters, such as the distance covered and the travel time. The electronic unit 310 comprises checking means 350 for checking the state of the vehicle 300, for example the operating range of the vehicle 300. If the vehicle 300 requires intervention (recharging of the battery), the checking means 350 can transmit a message to the computer centre 200 using the bidirectional communication means 330.

In order to simplify communication between a user 260 and a vehicle 300, the electronic unit 310 possesses a display device 360 which indicates the status of the vehicle 300. The display device 360 allows various states of the vehicle to be indicated. A first state is “I am available”. This state can for example be indicated by a green-coloured LED. A second state and the fact that the vehicle is reserved can be indicated by the display device. This state can be indicated by an amber-coloured LED. The display device 360 can also indicate that the car is unavailable, awaiting intervention or else is no longer in range. This third step can be indicated by a red LED.

The display device can indicate a plurality of other items of information, for example indicate to the user 260 that he is no longer entitled to use the vehicle. This may be the case if the subscription of the user 260 has expired or if he has not paid his invoices.

The method and the system according to the invention are adapted to afford greater insight into users' habits, as and when the users use the vehicles listed in the system. The system may operate as follows.

Initially, i.e. on day one, certain vehicles are arranged in an area so as to ensure acceptable accessibility for the first subscribers to the system. In principle, the vehicles are arranged close to the addresses indicated by the registered users.

The term “acceptable accessibility” means a distance, between the vehicle and a user's home, of between 2 and 3 minutes on foot.

The electronic centre is started up with the user profile established during initial marketing enquiries and recorded during the subscription interview with the first subscribers. On each trip, a certain number of parameters are recorded, such as the travel time, the distance, the precise itinerary, the downtime or else the precise parking location. The fact that these various parameters are recorded gradually enhances the database of the computer centre, to which the statistics obtained by the vehicles listed in the system may be added. For each user, the personalisation data will be used to optimise the rate of turnover of the vehicles while minimising user waiting time.

Alongside user movements, the team members, who can access the databases at any time to obtain information on the positions and the states of the vehicles, can also find out about the history of the use of the vehicles in order better to understand the movements of the vehicles within the system and get a better picture of the needs of the users of the vehicles.

At the same time, the model of the road networks in the computer centre is gradually enhanced with subtle characteristics. That means that the system becomes increasingly aware of areas in which it is impossible to park, no-entry areas, land use, travel time and the point-by-point congestion noted by the team members.

The fact that the system according to the invention is increasingly capable of analysing the mode of use of the vehicles gradually optimises the decision-making process. It is thus possible to ensure a user that a vehicle will be available within no more than 30 minutes, while at the same time minimising operating costs.

When a user wishes to use a vehicle listed in the system, he can show his badge to the vehicle indicated as being free or else contact the computer system to obtain information on the available vehicles.

After this, the user can use the vehicle, in the knowledge that at the end of his journey he will be invoiced according to distance and time. The user can leave the vehicle where he wishes within a geographical area predetermined by the operator of the system. He may be able to leave the vehicle outside this agreed area provided that he bears the costs for a team member to redistribute the vehicle within the area.

With regard to the invoicing of users, automated pricing can be put in place in which the price depends on the distances covered and the time of use. This information is transmitted to the computer centre in real time. It is possible to dynamically fix the prices for in-town journeys. That means that the charges depend on the time of day, time of year, and the geographical area in which the vehicle is used. Moreover, it is possible to create, for example, a first class of journeys within a limited distance such as 5 km and for a time of use of between 10 and 25 minutes. A person may use a vehicle for longer distances or periods, for which he will pay more. The process for invoicing the customer can vary from a prepayment system to a system for invoicing after use of the vehicle.

The system according to the invention may be used in combination with a backup system, thus offering users an alternative means of transport, should there be no available vehicle.

In principle, a user turns up at an available car or identifies himself and reserves an available vehicle at the computer centre. If the user learns that no vehicle is available, the system can calculate, on the basis of the information recorded in the database comprising the movements of all of the vehicles of the system, an average waiting time. If after this calculation it transpires that no vehicle is available within an acceptable time (approximately 30 minutes), the system can implement a backup procedure. The system will then organise the reservation of a taxi or another means of transport in order to ensure the availability of the means of transport within a given, contractual time.

The system according to the invention is particularly appropriate to be put in place firstly in one of the districts of a town. Once the system is working well in this district, the system can be extended by being put in place in a neighbouring district. Step by step, the geographical area in which the system operates may be extended.

In practice, it is in the interests of all that a plurality of other users join the service and take out a subscription. The more users there are, the more vehicles will be available in a given geographical area. For each registration of “n” new subscribers (for example n=10), a vehicle is added. This operation continues until a geographical area is completely covered. The larger the area covered by the system, the greater the freedom of use of the vehicles will be.

If the system is put in place district by district, it is in practice possible to organise the management thereof also on a district by district basis. That means that from time to time a vehicle from a first district that is left in a second district is returned by a team member to its original area. If each district has its own organisation, the computer system of each district is interconnected so as to be able to apply the same optimisation strategy.

The system according to the invention can be used alongside other public transport systems. That means that the vehicles listed in the system according to the invention are used in combination with buses, trams or trains. A first possibility is to sell subscriptions providing access both to the system according to the invention and to the conventional forms of public transport.

Another advantage of cooperation between the system according to the invention and the conventional public transport system consists in the fact that the data collected, by monitoring the movement of the vehicles within the system, can be used in order to optimise the movements of the vehicles used in conventional public transport.

FIG. 4 shows in detail the various states which the display device 301 can indicate, before or after communication with the computer centre 200 or else a user 260. After a start-up phase 400, the display means 360 indicates which vehicle 401 is available. The vehicle may receive reservation confirmation from the computer centre. In that case, the display device changes its state to a reserved state 402 in which the electronic unit 310 of the vehicle waits for a user to show his identification. If the user turns up, equipped with a correct identification means, the display device can change to a “ready for use” position 403. Conversely, if the identification badge is not correct, the display device can indicate that the badge is not acceptable 404. If a user does not appear with a correct badge or if he does not turn up within a given time, the reservation 402 is cancelled 403 and the display device resumes its available position 401.

An available car 401 can also be reserved by a user who appears with a badge. Once the badge is flashed at the vehicle, the electronic unit 310 of the vehicle makes contact with the computer centre to verify whether the user who has appeared is entitled to use the vehicle 405. If the badge is not valid, the display device 360 uses a red LED to indicate that the badge may not be accepted 406. If contact between the vehicle and the computer centre is not possible, the same message is indicated to the users 407. If the badge is correct, the procedure for providing the vehicle can commence 403. Firstly, a check-up is carried out 408 in the vehicle. That means that in the vehicle a check is carried out to determine whether the basic functions of the vehicle are working properly. Before the user can drive the vehicle, a check is carried out to determine that the doors are securely closed. If everything is OK, the user can drive the vehicle 410. As soon as the user stops, the vehicle is in a pause situation or at the end of its journey. If the vehicle is in a pause state, the vehicle waits for a badge to indicate whether the user wishes to put the vehicle on standby 412. Then, the vehicle again waits for the badge in order to start up again. If the badge is accepted, the procedure for providing the vehicle can recommence 413. If the badge is invalid, the vehicle indicates that the badge has not been accepted 414. Once a correct badge has been accepted, the procedure for checking the closed doors recommences 409, before the user can drive the vehicle. If the vehicle does not receive a valid badge, or for example receives the invalid badge of another user, this is indicated in the display device. After step 411 the user can also finalise the use of the vehicle. Again, the vehicle waits for the badge 416. If the badge is correct, the finalising procedure can be triggered 417; if not, the display device indicates that the badge is invalid 418. The finalising proceeds in contact with the computer centre to which the data concerning the journey is transmitted. If there is no available contact with the computer centre, for example if there is a GPRS failure, the system indicates an upload failure 419. Nevertheless, the user can continue to finalise the use of the vehicle. In the electronic unit 310 in the vehicle, all the data concerning the journey are stored. All this information is subsequently transferred to the electronic centre. The user does not need to wait for the time when the vehicle will again be able to make contact with the electronic centre.

As explained in detail hereinbefore, it is also possible that no vehicle will be available for the user. In that case, the system will use all the data from the database in order to calculate a prediction concerning the waiting time before a vehicle may be available for the user.

According to the invention, precise information concerning users' habits, and also the way in which they use the vehicles, is available in the database. In order to make a prediction concerning the waiting time for the provision of a vehicle, all the occupied vehicles are analysed. The vehicles are underway, somewhere, and in order to get an idea of the likely delay, the future movements of all the vehicles must be calculated. According to the invention, the way to make such a prediction starts with an analysis, for each vehicle, of the distance already covered by each of them. One at a time, it is necessary to identify whether each vehicle is at the start, midway through or at the end of its journey. However, as the vehicle progresses along its route, an algorithm is selected. The algorithm is used to calculate the most likely time and place for the vehicle to be made available. The selected algorithm is specially adapted for the state of progress of each vehicle. That means that there is one algorithm for calculating the future movement of a vehicle at the start of its journey, another appropriate for a vehicle midway through its journey and a third algorithm for a vehicle which has reached its destination.

If a vehicle has reached its destination, the procedure for predicting its future movement is for example as follows. In a first step, an occupied vehicle is identified. As a function of its position and of the direction at any given moment, an isochrone is calculated with the probable time which it still has to travel. The convex hull of this isochrone defines an area of probable travel of the vehicle.

In a second step, the total length of the arcs of this isochrone is calculated in the time interval. Moreover, the total length of the isochronous arcs which are in the areas is calculated.

The ratio is directly linked to the instantaneous probability of the vehicle ending its journey in the desired area. An additional weight is applied to the probable parking areas of the network. This weight is obtained by training. This method may be applied to the fleet of vehicles.

1. A method for placing at the disposal of a user one vehicle, to be used by this user, from a group of individual public vehicles, said method being characterised in that it includes the following steps:
obtaining from the vehicles of this group an item of information concerning the geographical position of the vehicle,
obtaining from the vehicles of this group an item of information concerning their availability for a user,
sending the information concerning the geographical position of the vehicles and their availability to a computer centre,
receiving and storing at the computer centre the information concerning the geographical position and the availability of the vehicles,
receiving at the computer centre a request to place at the disposal of a user a vehicle at a position,
comparing the information concerning the geographical position and the availability of the vehicles received at the computer centre with the request to provide a vehicle,
identifying a vehicle which is available at the position indicated by the user or close to this position, and
sending the user information concerning the geographical position of the vehicle and the delay before it will be available.

2. The method according to claim 1, said method including the following steps:
receiving from each individual public vehicle the information concerning the geographical movements of the vehicles,
creating a database comprising the information concerning the movements of the vehicles,
using the database in order to calculate indices concerning the movements of the vehicles in a geographical area in order to predict the future movements of the vehicles in this area.

3. The method according to claim 1, said method including the step of providing each individual public vehicle with a characteristic concerning its availability, receiving a request to provide a vehicle, confirming the availability of a certain vehicle, changing the characteristic of this vehicle from a first “available” state to a second “unavailable” state.

4. A system for placing at the disposal of a user one vehicle, from a group of individual public vehicles, to be used by the user, the system comprising a computer centre and one or more vehicles, wherein this computer centre is provided with communication means for communicating with each vehicle and wherein the vehicles are provided with precise locating means and with communication means for sending information concerning their geographical position to this computer centre wherein the vehicles are configured for sending the information concerning the geographical position of the vehicles and their availability to a computer centre, and wherein the computer centre is configured for:
obtaining from the vehicles of this group an item of information concerning the geographical position of the vehicle,
obtaining from the vehicles of this group an item of information concerning their availability for a user,
receiving at the computer centre a request to place at the disposal of a user a vehicle at a position,
comparing the information concerning the geographical position and the availability of the vehicles received at the computer centre with the request to provide a vehicle,
identifying a vehicle which is available at the position indicated by the user or close to this position, and
sending the user information concerning the geographical position of the vehicle and the delay before it will be available.

5. The system according to claim 4, wherein the communication means are adapted to allow the vehicles to send information concerning their geographical position continuously.

6. The system according to claim 4, wherein the computer centre is adapted to communicate with a user, to allow the user to access the information concerning the geographical position of the vehicles.

7. The system according to claim 4, wherein the communication means are adapted for GSM, 2G, 3G or WIFI-type wireless communication.

8. A vehicle adapted for the system according to claim 5, said vehicle being provided with precise locating means allowing the vehicle to know its exact geographical position and with communication means for sending its exact position.

9. The vehicle according to claim 8, said vehicle being provided with means for communicating with a user, to allow the vehicle to recognise a registered user and to allow the user access to the vehicle.

10. The vehicle according to claim 9, wherein the means for communication between the vehicle and the user are equipped with authentication means using an RFID protocol.

11. The vehicle according to claim 8, said vehicle being provided with a display device, visibly indicating the characteristic of the vehicle concerning its availability.

12. A computer readable medium having stored therein executable instructions that when executed by the processor of a computer control the computer to perform steps comprising:
obtaining from the vehicles of this group an item of information concerning the geographical position of the vehicle,
obtaining from the vehicles of this group an item of information concerning their availability for a user,
sending the information concerning the geographical position of the vehicles and their availability to a computer centre,
receiving and storing at the computer centre the information concerning the geographical position and the availability of the vehicles,
receiving at the computer centre a request to place at the disposal of a user a vehicle at a position,
comparing the information concerning the geographical position and the availability of the vehicles received at the computer centre with the request to provide a vehicle,
identifying a vehicle which is available at the position indicated by the user or close to this position, and
sending the user information concerning the geographical position of the vehicle and the delay before it will be available.

13. (canceled)
